(19) United States
(12) Patent Application Publication
(10) Pub. No.: US 2015/0132193 A1
(43) Pub. Date: May 14, 2015

(54) Particulate Filter Designed as a Partial Filter

(71) Applicant: HJS Emission Technology GmbH & Co. KG, Menden (DE)

(72) Inventors: Herman-Josef Schulte, Menden (DE); Klaus Schrewe, Ruthen (DE); Jochen Koll, Arnsberg (DE); Simon Steigert, Menden (DE)

(21) Appl. No.: 14/398,711

(22) PCT Filed: Mar. 11, 2013
(86) PCT No.: PCT/EP2013/054883

§ 371 Date: Nov. 3, 2014

(30) Foreign Application Priority Data
Jun. 4, 2012 (DE) 102012104834.7
Jun. 4, 2012 (DE) 202012102041.6

(51) Int. Cl. F01N 3/022; F01N 3/031; B01D 53/94; B01D 46/00

(52) U.S. Cl. CPC F01N 3/0222; B01D 46/0023; F01N 3/031; B01D 53/94
USPC 422/171; 55/482; 55/309; 422/169

(57) ABSTRACT

The invention relates to a particulate filter (1) designed as a partial filter, particularly as a soot particulate filter for removing soot particles from the exhaust gas flow of an internal combustion engine, said filter comprising a filter block unit (3) that is held in a filter housing (2), is designed as a channel filter and comprises a plurality of parallel channels (6, 6.1) which are separated from one another by filter walls (7). The filter block unit (3) comprises at least two filter blocks (5, 5.1) connected one behind the other in the direction of the exhaust gas flow. Each filter block (5, 5.1) is designed as a partial filter, with a first plurality of the channels of each filter block (5, 5.1) being open on the outflow side, and a further plurality thereof being closed on said outflow side.

The invention relates to a particulate filter designed as a partial filter, particularly as a soot particulate filter for removing soot particles from the exhaust gas flow of an internal combustion engine, and comprising a filter block unit that is held in a filter housing, is designed as a channel filter and comprises a plurality of parallel channels which are separated from one another by filter walls.

Such particulate filters are used, for example, for cleaning the exhaust gases of vehicles operated by diesel engine. Using such filters, the soot particles entrained in the exhaust gas flow are filtered out of the exhaust gas flow. In addition to sintered metal-based particulate filters, particulate filters with a filter block made of a ceramic material are also used. Such a filter block is designed as a channel filter and it has a plurality of parallel channels along the longitudinal extent of the filter block and separated from one another by filter walls. The cross-sectional geometry of the channels can be square. Other cross-sectional geometries are also used. The filter channels of such a channel filter are closed alternatingly on the inflow side and on the outflow side. This means that the exhaust gas flowing into a channel that is closed on the outflow side has to pass through the filter walls of this channel in order to reach a channel that is open on the outflow side and arranged adjacent to the former channel. In this way, the filter walls constitute the filter medium in such a filter. Due to the parallel arrangement of the channels that are alternatingly open on the inflow side and on the outflow side, these channels are also sometimes referred to as honeycomb filters.

In addition to particulate filters in which all the exhaust gas has to pass through the filter walls in every operating state of the filter, and which are therefore also referred to as full filters, particulate filters that have one or more potential bypass routes are also used. Here the one or more potential bypass routes are importantly used for the purpose of allowing the exhaust gas to flow through the filter housing, even if the filter body unit opposes a relatively high exhaust gas counter pressure caused by a particularly high soot particle load. If the exhaust gas counter pressure is excessively high, this affects the operation of the internal combustion engine. It is true that such particulate filters are regenerated at time intervals by inducing soot oxidation. However, the soot oxidation cannot be carried out in every operating state of a motor vehicle. In such a regeneration, also referred to as soot combustion, one must ensure that it is carried out as completely as possible, which in turn means that sufficient time must be available during which the engine is still running Various strategies are known to determine the best possible time for such a particulate filter regeneration, and then trigger the regeneration process by supplying heat. Situations can thus always keep arising in which a regeneration of the particle is indeed desirable but cannot be triggered. In such cases, potential bypass routes ensure that the exhaust gas counter pressure is not excessively high in spite of a high particulate filter load.

In many cases, a 100% filtration is also not required in reference to the legal limit values. An adjustment to the required separation rate helps lower the fuel consumption.

Various bypass solutions used in particulate filters are known in the prior art. For example, in DE 10 2005 023 518 A1, a blockage-free filter unit is described, in which the filter block units are arranged with spacing one after the other in the flow direction and there is a bypass around each filter block unit. This ensures a partial flow around the respective filter block unit.

In ceramic filter blocks, bypasses inside the filters are also implemented. Ceramic filter blocks with a base body with the filter walls are produced by way of an extrusion process. In a subsequent step, the first open channels are alternatingly closed at their ends by the insertion of a closing plug. To provide potential bypass routes, it is known from EP 1 408 208 B1 to provide the outflow-side closing plugs with a through-hole. In light of the fact that the cross section of the channels of such a ceramic honeycomb filter can only be approximately 1.5 mm, it is difficult to introduce this through-hole at a later time into the closing plugs. In addition, with the through-holes then inevitably having only a very small diameter, there is a risk that they already become blocked in the presence of small soot quantities or ash quantities, and thus lose their effectiveness.

U.S. Pat. No. 7,128,961 B2 discloses a ceramic honeycomb filter in which several wall crossing points are not formed already at the time of the extrusion of the base body. As a result, a potential bypass route exists over the entire length of the filter between two channels that are open on the inflow side and two channels that are open on the outflow side. In the particulate filters disclosed in this document, the potential bypass routes are incorporated during the manufacturing of the filter base body, in particular during the extrusion. As a result, such a filter body cannot be produced using the usual tools. Moreover, in the concept disclosed in this document, the effective cross-sectional area of the flow of such a bypass can be adjusted only with difficulty. The space to be kept clear between otherwise mutually abutting filter walls would have to be kept very small in this design, so that the total potential route of the bypass extending over the entire length of the filter is not excessively large.

On the basis of this discussed prior art, the invention is based on the problem of further developing a particulate filter as mentioned in the introduction in such a manner that it can be produced in a simple way and thereby above all cost effectively, while still ensuring a sufficient separation degree.

This problem is solved according to the invention with a ceramic particle filter according to the preamble mentioned in the introduction, in which the filter block unit comprises at least two filter blocks connected one after the other in the flow direction of the exhaust gas, wherein each filter block is designed as a partial filter, in that a first plurality of the channels of each filter block is open on the outflow side and an additional plurality is closed on the outflow side.

In the concept of this filter block unit, at least two filter blocks are arranged one after the other in the flow direction of the exhaust gas. Each filter block is designed as a partial filter, so that a plurality of its channels is closed on one end and the additional plurality is open. By means of this design, particulate filters implemented as partial filters can be produced in different designs. Thus, according to a first embodiment example, it is provided to combine at least two filter blocks to form the filter block unit, wherein the closure side of each filter block is on the outflow side. Each one of these filter blocks thus provides a partial filter. By connecting at least two such filter blocks one after the other, the separation degree can be adjusted. Here it is possible to provide that the longitudinal extent of the filter blocks and thus the length of the channels of each filter block are different. For example, the filter block arranged on the inflow side can be shorter than the filter block connected downstream of the former filter block in the flow direction. In such a design, the separation rate in the first filter block will be smaller than in the second filter block.

According to an additional design, it is provided that the filter block unit comprises a first filter block arranged in the filter housing on the inflow side and having channels in which only the channels of the first plurality are closed on their inflow end, and a second filter block in the filter housing connected downstream of the first filter block in the flow direction of the exhaust gas and having channels in which only the channels of the second plurality are closed on their outflow end, that the first and the second filter blocks abut against each other on the end side, and that, starting from the end face of at least one of the two filter blocks, cutouts are made as potential bypass routes in some of the filter walls separating two adjacent channels. The cutouts can naturally also connect several channels to one another, and consequently they can extend through several or also a plurality of filter walls.

In the case of this particulate filter, the filter block unit is composed of two filter blocks. The two filter blocks each have a plurality of parallel channels. The special feature of the two filter blocks is that in one filter block a first plurality of filter channels is closed on the inflow side and in the other filter block the second plurality of channels is closed on the outflow side; consequently these channels are provided in each case with a closing plug. The two filter blocks of the filter block unit are arranged in the filter housing with respect to one another in such a way that the filter block is arranged with the inflow-side closing body, on the inflow side, opposite the other filter block, in the filter housing. The second filter block is thus in an arrangement connected downstream of the first filter block in the flow direction of the exhaust gas. In this block, the closing plugs closing the corresponding plurality of channels are located on the outflow side of this filter block. The two filter blocks abut against one another with their mutually facing end sides. It is preferable that the pluralities of the channels of the two filter blocks are held in a mutually aligned arrangement in the filter housing, and consequently they form in the end in principle a filter body known per se with channels alternatingly closed on the inflow side and on the outflow side. The special feature of these particulate filters is that, for the formation of the potential bypass route in the area of at least one of the two mutually facing end faces of the two filter blocks, cutouts are produced in filter walls separating adjacent channels. These cutouts start from the respective end face facing the closing plug and they extend over a predefined length in axial direction. These cutouts in the filter walls form potential transverse routes through which the exhaust gas flowing into the channels that are open on the inflow side can flow directly into channels that are open on the outflow side. In this way, potential bypass routes are formed, through which the exhaust gas flowing into the particulate filter can flow through said filter without having to penetrate through the filter walls. Typically, the potential bypass routes have a cross-sectional area the total of which allows only a portion of the exhaust gas flowing into the filter body unit to pass unfiltered through it, for example, up to 20%. It is understood that, depending on the required specifications, a larger proportion of the exhaust gas flowing through a filter block unit can also flow unfiltered through the filter block unit, in the case of an appropriate design of the potential bypass routes. This is not intended to rule out that, for a short time, most or all the exhaust gas actually flows through the potential bypass routes in situations that occur only rarely during normal operation, for example, in the case of an excess soot load of the filter block unit, or in the case of the operation of the internal combustion engine with only a small load or during idling operation.

The design of the potential bypass route by providing cutouts, starting from the end face of at least one of the two filter blocks, allows a very precise design of the potential routes and the flow cross-sectional area established thereby. This is achieved by the fact that, on the one hand, such a cutout can extend over the entire cross-sectional area of a filter wall or also over only a portion thereof. On the other hand, this is due to the fact that the cross-sectional area, through which flow can pass, of such a potential bypass route is also defined by the axial extent of such a potential path. Thus, in this design, two variables exist by means of which the effective cross-sectional area of potential bypass route can be adjusted.

In the subject matter consisting of the particulate filter it is particularly advantageous that it is possible to form potential bypass routes subsequently, that is to say after manufacturing a conventional filter block unit. Thus, one and the same outlet filter block can be used in order to form application-specific potential bypass routes of different cross-sectional area without having to change the manufacturing process itself. The cutout can then be produced subsequently, for example, by drilling, milling or the like.

In addition, in an application-specific manner, at the time of a subsequent production of the potential bypass routes, the uniform distribution of the exhaust gas flowing into the filter block unit can be taken into consideration. In the case of an ideal uniform distribution of the exhaust gas flowing into the particulate filter, one distributes the potential bypass routes uniformly over the cross-sectional area of the filter block. If the uniform distribution is not ideal, then, if desired, the potential bypass routes can be arranged, for example, in those areas which entrain fewer soot particles due to the nonuniform distribution. Depending on the desired goal, the arrangement can also be reversed.

In this embodiment example, the potential bypass routes can connect together two or more, for example, four adjacent channels, depending on the design of the channel cross sections.

For the preparation of such a filter body unit, it is possible to start with a conventional full filter with alternatingly closed channels on the end side. Starting with such a filter block, the latter is divided in the transverse direction, for example, in the area of the center, for the formation of the two filter blocks according to the invention. In this way, a first filter block, with channels of the first plurality of channels closed on the inflow side, and a second block, with channels of the second plurality of channels closed on the outflow side are produced. This design ensures above all that, in the case of an end-side mutual abutment of the two filter blocks, the latter can be brought into an aligned arrangement in terms of their channels, if this is to be provided. In a preferred embodiment, the two filter blocks are mutually aligned in the particulate filter in such an arrangement. Connecting pins can be inserted into individual filter channels. No tolerances have to be compensated in this design, which would have to be accepted in the case of the use of two individually produced filter blocks. The splitting of a full filter with channels closed alternatingly on the end side, which is referred to in the context of these explanations as a production filter body, for the preparation of the two required filter blocks, in addition has the advantage that the splitting can be carried out so that the two filter blocks abut against another with precise fit, which can be advantageous when the filter blocks are supposed to abut against one another with their end faces in order to form the filter body unit. Such a mutual abutment with precise fit can also be achieved in such a manner that the two end faces of the filter blocks are hooked together in the transverse direction, which is typical for fracture planes, for example. Therefore, it is provided according to a design, to split the production filter body in such a manner that a fracture plane is provided over at least a partial cross-sectional area. This can be achieved by a slanted or curved splitting of a production filter body.

The claimed concept of forming the filter block unit with two filter blocks in the described manner moreover has the advantage that the application of a catalytic coating is simplified. Finally, in the two filter blocks, only one plurality of the parallel channels is closed. In addition, the possibility readily exists of providing the two filter blocks with a different catalytic coating. According to an additional design it is provided that the filter block arranged on the inflow side is catalytically coated on its inflow filter surface and the other filter is catalytically coated on its outflow filter surface.

The special particulate filter design also makes it possible for an additional filter block to be located between the two filter blocks. However, this additional filter block does not have channels that are closed on the end side. Rather, its channels are used for connecting the channels of the first filter block to those of the filter block arranged on the outflow side. Nevertheless, the possibility exists, in the case of this interposed filter block, for example, of providing it with a different catalytic coating. Instead of an additional filter block arranged between the filter blocks, a catalytically coated central piece of the production filter can also be arranged at this site.

The two filter blocks are typically held with their mutually facing end sides abutting against one another in the filter housing, in particular also with the interposition of a resilient compensation material, for example, a wire mesh.

Additional advantages and variants of the invention can be obtained from the following description of embodiment examples taking into consideration the appended figures.

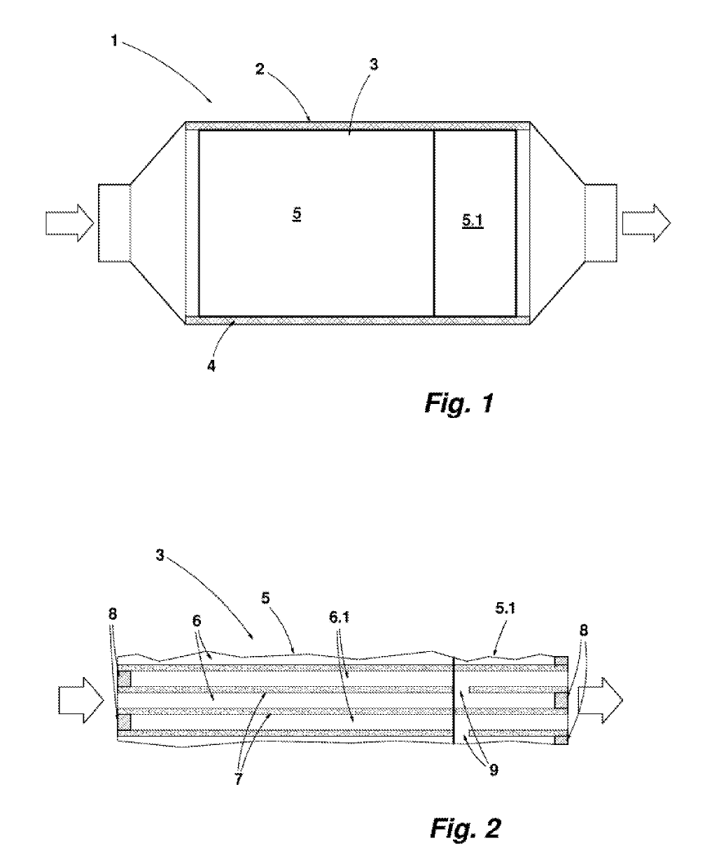

FIG. 1 shows: a view with partial cutaway of a particulate filter according to a design of the invention,

FIG. 2 shows: a detail of the filter block unit of FIG. 1 constructed from two filter blocks, in a longitudinal section,

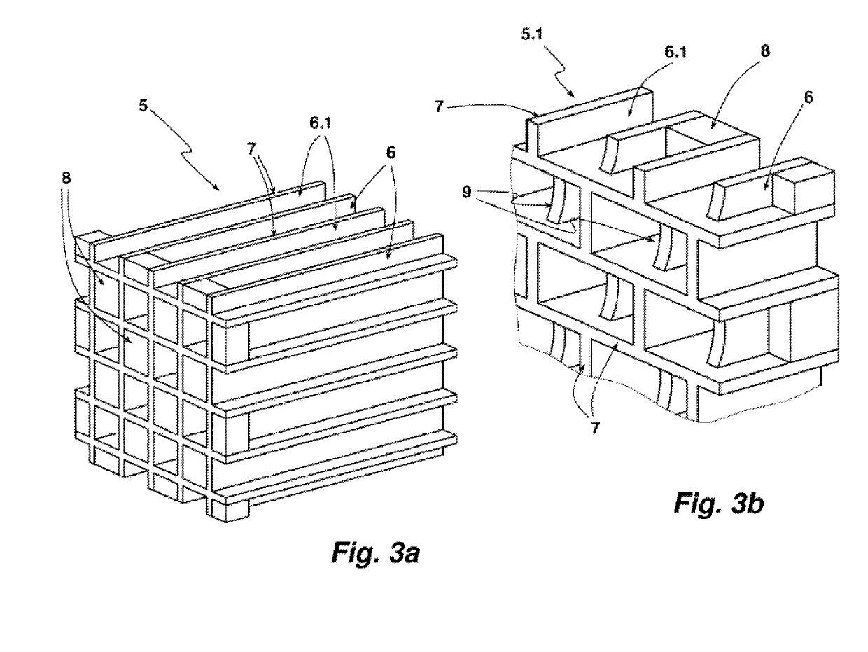

FIGS. 3a, 3b show: a perspective view of a detail of the filter block (FIG. 3a) arranged on the inflow side, and of the filter block (FIG. 3b) arranged on the outflow side, which is represented enlarged in comparison to the first filter block,

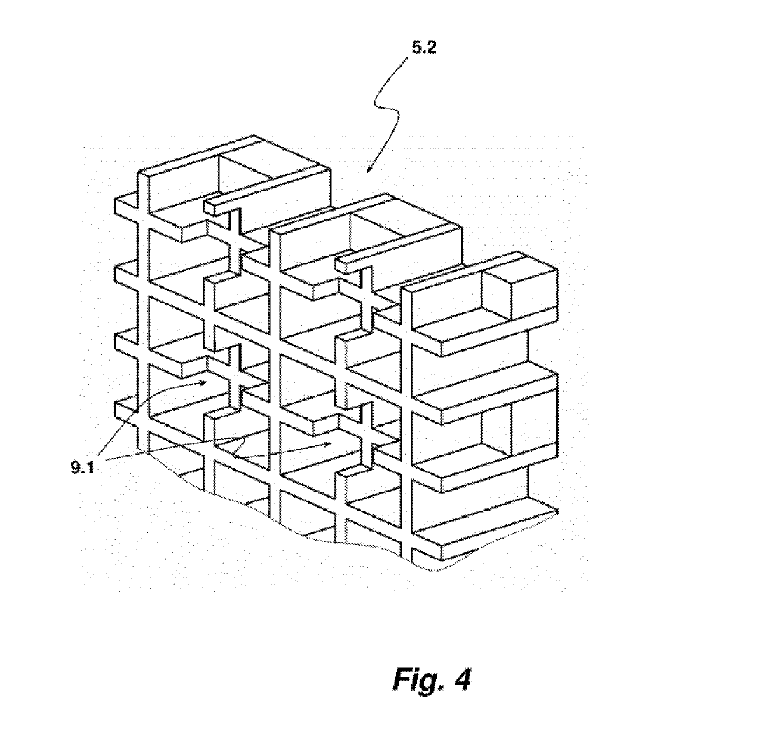

FIG. 4 shows: a design of the filter block arranged on the outflow side, according to another design for providing potential bypass routes,

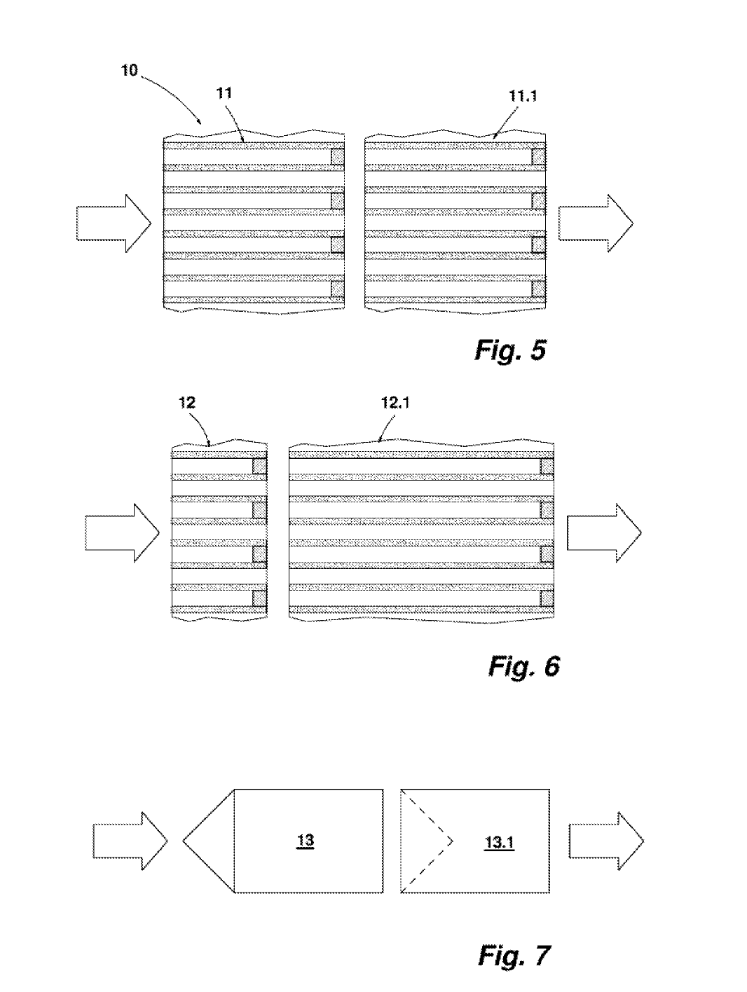

FIG. 5 shows: a diagrammatic representation of another embodiment example of a filter block unit formed from two partial filter blocks, as particulate filter,

FIG. 6 shows: a diagrammatic representation of yet another embodiment example of a filter block unit formed from two partial filter blocks, as particulate filter, and

FIG. 7 shows: a diagrammatic representation of yet another embodiment example of a filter block unit formed from two partial filter blocks, as particulate filter.

A particulate filter 1, provided for installation in the exhaust gas system of a diesel internal combustion engine, comprises a filter block unit 3 received in a filter housing 2 and held therein. The filter block unit 3 is held in a stationary position in the filter housing 2, with the interposition of a mounting mat 4 consisting of a wire mesh in the represented embodiment example. The filter block unit 3 of the represented embodiment example consists of two filter blocks 5, 5.1. The filter blocks 5, 5.1 are manufactured from a ceramic material in the form of a honeycomb filter. Accordingly, a plurality of parallel channels extends through the filter block unit 3 in the longitudinal extent (see FIG. 2). Adjacent channels are closed alternatingly on the inflow side and on the outflow side. The channels closed on the outflow side are marked with the reference numeral 6 and the channels closed on the inflow side are marked with the reference numeral 6.1. The channels 6, 6.1 are in each case separated from one another by a filter wall 7. The cross-sectional geometry of the channel 6, 6.1 is square, so that each channel 6, 6.1 is enclosed by four filter walls 7. The filter walls 7 are used for filtering the exhaust gas flowing into the channels 6 that are closed on the outflow side, when this exhaust gas passes through the filter walls 7. Particles in the exhaust gas, particularly soot particles, are then retained and accumulate successively on the inflow-side surface of the channels 6 closed on the outflow side and open on the inflow side. The channels 6, 6.1 are closed by means of a closing plug 8. Thus, in the filter block unit 3, the channels 6 closed on the outflow side form a first plurality and the channels 6.1 closed on the inflow side form a second plurality.

The filter block unit 3 consists of the two filter blocks 5, 5.1 which are arranged one after the other in the flow direction and which abut against one another with their mutually facing end sides. These filter blocks 5, 5.1 are held in this mutually abutting arrangement by the enclosure in the mounting mat 4 and by the integration in the filter housing 2. Thus, the two filter blocks 5, 5.1 first are in any case mutually independent bodies, which are only brought together in the mutual arrangement depicted for the formation of the filter block unit 3. In this arrangement the longitudinal axial channels of the two filter blocks 5, 5.1 are in alignment with one another.

The filter block 5 comprises, as can be seen in FIG. 2, in a first plurality, unclosed channels, namely the partial channels of channels 6, and a second plurality of channels closed on the inflow side, namely portions of the channels 6.1. The arrangement is reversed in the filter block 5.1. In this filter block 5.1, the channel portions 6 are closed on the outflow side, while the portions of the channels 6.1 are open on the outflow side.

The filter bodies 5, 5.1 were produced in the conventional manner by extruding a base body having the filter channels, into which base body, in a subsequent step, the closing plugs 8 were inserted alternatingly on opposite ends. This can also take place after the firing of the filter body. In a subsequent step, this production filter body is sectioned in the transverse direction, in order to produce the two filter bodies 5, 5.1. As a result, the two filter bodies 5, 5.1 can be positioned on the end side at the separation site with precise fit and with all the channels in mutual alignment.

The manufacturing body is split so that, starting from the end face of one of the two filter blocks, potential transverse flow routes for the formation of a plurality of potential bypass routes can be arranged. In the represented embodiment example, the arrangement is provided on the rear filter block 5.1 in the flow direction of the exhaust gas, on its end side pointing toward the filter block 5. In the latter filter block, according to a predetermined grid, starting from the end face of the filter block 5.1 pointing toward the filter block 5, sections of filter walls separating two adjacent channels are removed for the formation of cutouts, for example, by drilling or milling. This can be seen in the three-dimensional representation of a detail of the two filter bodies 5, 5.1. These potential bypass routes are marked with the reference numeral 9. By removing discrete filter wall sections, in this embodiment example, in each case a channel 6 closed on the outflow side is connected to a channel 6.1 open on the outflow side. It is understood that the total of the potential bypass routes 9 through which a flow can pass is not sufficiently large so that the exhaust gas flowing into the filter block unit 3 overall could pass only via the potential bypass routes 9 through the filter block unit 3. Instead, the cross-sectional area of the total of the potential bypass routes 9 is given dimensions so that the remaining exhaust gas counter pressure is still sufficiently high so that, at least up to a defined or definable filter load, the exhaust gas flowing into the filter block unit 3 flows predominantly through the filter wall 7.

FIG. 4 shows another possible design for introducing potential bypass routes into a filter block. FIG. 4, like FIG. 3b, shows the rear filter block 5.2 in the flow direction, in a view onto its end face pointing toward its filter block connected upstream in the flow direction. In contrast to the filter block 5.1, in this filter block 5.2, the potential bypass routes 9.1 are introduced at the crossing points of filter walls. In this manner, in each case, two filter channels closed on the outflow side are connected with two filter channels open on the outflow side.

As can be seen particularly in FIGS. 3b and 4, it is not only the axial extent of the same extent forming cutouts in the filter walls 7 that influences the sizing of the effectiveness of the potential bypass routes 9, 9.1, but also the extent of such a cutout in the transverse plane.

In addition to the above-described measures, it is possible to provide that the two filter blocks 5, 5.1 mutually abutting at the end side are arranged with a small gap, if a correspondingly larger potential bypass route is to be produced.

In the embodiment examples, the potential bypass routes in the rear filter block in the flow direction are introduced starting from an end face pointing toward the other filter block. It is understood that these routes can also be introduced into the end face of the first filter block pointing toward the rear block, or also into both.

In the represented embodiment example, the rear filter block 5.1 in the flow direction is shorter than the first filter block 5. This too should be understood to be an example. A division of a production filter block is also readily possible at another site, for example, in the center, for implementing the invention.

FIG. 5 diagrammatically shows an additional embodiment of a particulate filter, the filter block unit 10.1 of which is formed from two filter blocks 11, 11.1 formed each as a partial filter. In the case of the filter blocks 11, 11.1, it is likewise a matter of channel filters with in each case a plurality of channels closed at one of their ends and an additional plurality of continuously open channels. The filter blocks 11, 11.1 are connected in the same direction one after the other in contrast to the arrangement of the filter blocks 5, 5.1 in the filter block unit 3 of the previous embodiment example. The closing side of the filter blocks 11, 11.1 is oriented downstream. In the represented embodiment example, the channels of the filter blocks 11, 11.1 are alternatingly open and closed. Other divisions are also possible. The filter blocks 11, 11.1 of the filter block unit 10.1 are of equal size. The filter blocks 11, 11.1 are also produced using a production filter which is sectioned in the area of its center to form the two filter blocks 11, 11.1. Subsequently, the filter blocks 11, 11.1 are brought into the alignment and arrangement shown in

FIG. 5. The filter blocks 11, 11.1 like those of the filter block unit 3 are maintained with interposition of a mounting mat in a filter housing.

In a design in which the two partial filters are connected one after the other in the same direction, as is the case in the particulate filter of the embodiment example of FIG. 5, the goal in principle is to achieve a separation degree of more than 50% of the soot entrained in the exhaust gas flowing through the particulate filter.

The separation degree is adjusted in the design of the filter blocks 11, 11.1 by the porosity of the channel walls and by the channel and cell density per unit of surface area. Sometimes the length of the respective filter block is also included. Here, filters having a wall porosity between 40 and 75% are used. It is preferable to use wall porosities from 55 to 70%, moreover preferably between 60 and 65%. Interestingly, it has been found that outside of this range the separation degree is too low. The channel density or cell density per unit of surface area is usually indicated using the unit “cells per square inch (cpsi).” It is preferable to use filter blocks with 100 to 400 cpsi, preferably between 200 and 350 cpsi.

FIG. 6 shows an alternative to the embodiment example of FIG. 5 in which filter blocks 12, 12.1 are of unequal length, wherein the filter block 12 arranged on the inflow side is shorter than the filter block arranged thereafter in the flow direction.

FIG. 7 shows yet another embodiment example, in which two partial filters are connected one after the other in the same direction. The two filter blocks 13, 13.1 have a rotationally symmetric geometry on the inflow side. This is done in order to counter an uneven distribution of soot in the exhaust flow. The front filter block 13 on the inflow side narrows conically on the inflow side. The filter block 13.1 arranged on the outflow side has a complementary recess. Other section shapes, in particular asymmetric, are also possible.

In all the embodiment examples described, flow directing and/or heat directing inserts can also be provided between the filter blocks alone or jointly with one or more other units. This equally applies to an arrangement of such elements before and after the filter block units.

The description of the different embodiment examples is made in reference to ceramic filter blocks. It is understood that, instead of a ceramic material, other materials, such as sintered metal, for example, can be used for the formation of the channel filters.

The features described in the individual embodiment examples in combination with one another can also be combined independently of one another or in another combination with one another.

The design of the filter block unit with at least two filter blocks also has a positive effect in reference to thermal stresses. Due to this design, the length of the individual filter bodies is accordingly short, in particular shorter than the length of a conventional filter block unit made as a single part. Different thermal effects on the two filter blocks, due to the loose mutual abutment, do not necessarily lead to stresses in the other filter block.

### LIST OF REFERENCE NUMERALS

1 Particulate filter

2 Filter housing

3 Filter block unit

4 Mounting mat

5, 5.1, 5.2 Filter block

6, 6.1 Channel

7 Filter wall

8 Closing plug

9, 9.1 Potential bypass routes

10 Filter block unit

11, 11.1 Filter block

12, 12.1 Filter block

13, 13.1 Filter block

1. Particulate filter designed as a partial filter, particularly as a soot particulate filter for removing soot particles from the exhaust gas flow of an internal combustion engine, and comprising a filter block unit (3) that is held in a filter housing (2), is designed as a channel filter and comprises a plurality of parallel channels (6, 6.1) which are separated from one another by filter walls (7), characterized in that the filter block unit (3) comprises at least two filter blocks (5, 5.1; 11, 11.1; 12, 12.1; 13, 13.1) connected one after the other in the flow direction of the exhaust gas, wherein each filter block (5, 5.1; 11, 11.1; 12, 12.1; 13, 13.1) is designed as a partial filter, in that a first plurality of the channels of each filter block (5, 5.1; 11, 11.1; 12, 12.1; 13, 13.1) is open on the outflow side and an additional plurality is closed on the outflow side.

2. Particulate filter according to claim 1, characterized in that the filter blocks (5, 5.1; 11, 11.1; 12, 12.1; 13, 13.1) are sections of a filter block produced as a full filter.

3. Particulate filter according to claim 1 or 2, characterized in that the filter block unit (3) comprises a first filter block (5) arranged in the filter housing (2) on the inflow side, with channels in which only the channels (6.1) of the first plurality are closed on their inflow-side end, and a second filter block (5.1) connected in the filter housing (2) downstream of the first filter block (5) in the flow direction of the exhaust gas, with channels (6) in which only the channels (6) of the second plurality are closed on their outflow-side end, in that the first and the second filter blocks (5, 5.1) mutually abut on the end side, and in that, starting from the end face of at least one of the two filter blocks (5, 5.1), cutouts are made as potential bypass routes (9, 9.1) in some of the filter walls (7) separating two adjacent channels (6, 6.1).

4. Particulate filter according to claim 3, characterized in that the cutouts (9.1) are arranged in the area of the crossing points of the filter walls (7), and the channels (6, 6.1), which are delimited by filter walls (7) forming such a crossing point, are connected thereby to one another.

5. Particulate filter according to one of claims 1 to 4, characterized in that the channels (6, 6.1) of the at least two filter blocks (5, 5.1; 11, 11.1; 12, 12.1; 13, 13.1) are arranged with mutual alignment.

6. Particulate filter according to claim 2, characterized in that the two end faces of the filter blocks (5, 5.1) mutually abut with precise fit.

7. Particulate filter according to claim 6, characterized in that the two mutually abutting end faces of the two filter blocks (5, 5.1) have complementary fracture structure at least in a partial area.

8. Particulate filter according to one of claims 1 to 7, characterized in that the two filter blocks (5, 5.1; 11, 11.1; 12, 12.1; 13, 13.1) are held, with interposition of a heat-resistant resilient compensation material, for example, of a mounting mat (4), in the filter housing (2).

9. Particulate filter according to one of claims 1 to 8, characterized in that at least one of the two filter blocks of the filter block unit is catalytically coated.

10. Particulate filter according to claim 8, characterized in that the two filter blocks have a different catalytic coating.

11. Particulate filter according to claim 9 or 10, characterized in that the filter block arranged on the inflow side is catalytically coated on its inflow-side filter surface and the second filter body is catalytically coated on its outflow-side filter surface.

12. Particulate filter according to one of claims 1 to 11, characterized in that the channels of the first filter block are held with the channels of the second filter block in an nonaligned arrangement in the filter housing, wherein the two filter blocks are arranged mutually offset relative to one another by some angular amount around the longitudinal axis of the filter block.

13. Particulate filter according to one of claims 1 to 5 or 8 to 12, characterized in that the two filter blocks of the filter block unit are spaced apart from one another.

14. Particulate filter according to claim 13, characterized in that, between the two filter blocks of the filter block unit, an additional unit, in particular a unit for exhaust gas purification, for example, a catalytic converter, is inserted.
